(19) United States
(12) Patent Application Publication
(10) Pub. No.: US 2002/0091935 A1
(43) Pub. Date: Jul. 11, 2002

(54) Storage and retrieval of encrypted content on storage media

(75) Inventors: G. Scott Smith, San Jose, CA (US); Jose Diaz, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sony Corporation, a corporation of Japan, Tokyo (JP)

(21) Appl. No.: 09/898,319

(22) Filed: Jul. 2, 2001

Related U.S. Application Data
(60) Provisional application No. 60/224,619, filed on Aug. 11, 2000.

(51) Int. Cl. H04L 9/32

(52) U.S. Cl. 713/189; 380/284

(57) ABSTRACT

In a communication system having a terminal for receiving encrypted content, the terminal being coupled to a storage media via an IEEE 1394 serial bus, a method for storing the encrypted content on the storage media. The method includes (1) receiving the encrypted content via the IEEE 1394 bus; (2) encrypting a first key for decrypting the encrypted content to form a second key; (3) combining the encrypted content with the second key to form a combined encrypted content stream; and (4) storing the combined encrypted content stream on the storage media.

### BACKGROUND OF THE INVENTION

The present invention relates generally to the field of cryptography and more specifically to a system for storing encrypted content.

Conventional systems for storing content on storage devices are well known. One such content is video content such as a movie, for example. There are various instances in which such content may be stored. For example, DVD) (digital video disk) manufacturers store the video content for selling and distribution to the end consumer. Similarly, a set-top box receiving content from a cable system head-end may wish to time-shift content. For example, if the user wishes to pause real-time content, the content is saved on a storage media such as a hard disk platter, after which is replayed when the user is ready. A requirement for storing content is that such content be encrypted so that it is inaccessible to unauthorized users, even where the content is temporarily stored. This is because a fundamental problem facing content providers is how to prevent the unauthorized use and distribution of digital content. Content providers are concerned with getting compensated for their work. Unauthorized copying and use of content providers works deprives rightful owners of billions of dollars according to a well-known source. Unauthorized copying is exercebated because consumers can easily retrieve content, and technology is available for perfectly reproducing content.

Many schemes for preventing unauthorized access are typically implemented using “encryption/decryption” of the digital content. Encryption is the conversion of data into an unintelligible form, e.g., ciphertext, that cannot be easily understood by unauthorized users. Decryption is the process of converting encrypted content back into its original form such that the it becomes intelligible. Simple ciphers include the rotation of letters in the alphabet, the substitution of letters for numbers, and the “scrambling” of voice signals by inverting the sideband frequencies. More complex ciphers work according to sophisticated computer algorithms that rearrange the data bits in digital information content.

In order to easily recover the encrypted information content, the correct decryption key is required. The key is an algorithm that decodes the work of the encryption algorithm. The more complex the encryption algorithm, the more difficult it becomes to decode the communications without access to the key. Generally, there are two types of key schemes for encryption/decryption systems, namely (1) Public Key Systems (PKS) or asymmetric systems which utilize two different keys, one for encryption, or signing, and one for decryption, or verifying; and (2) nonpublic key systems that are known as symmetric, or secret key, systems.

Even where content has been successfully encrypted and transmitted, the problem of storage still exists. Consider a digital distribution system, for example, wherein an Audio/Video (AV) distribution system utilizing the IEEE 1394 Serial Bus (1394) as a transport mechanism, as below.

FIG. 1 shows a prior art digital system 100 for storing encrypted data received over a 1394 bus. A 1394 interface module 102 is used to receive the encrypted data 104 and to produce unencrypted data 106 for storage on storage media 108. The system 100 stores data in unencrypted format, which may present a security problem since the data is unprotected. The above discussed security problem cannot be overcome simply by storing encrypted data on the storage media, since this technique introduces new problems. Such a technique fails to account for the numerous keys used when transmitting encrypted digital data. For example, to improve security, the keys for encrypting data over the 1394 bus are periodically changed. One problem can occur when the keys used to encrypt the stored original data stream are not used when retrieving the data from the media. Thus, the data cannot be recovered. For example, consider the following transactions.

Sending a data stream from A to B starts with negotiating a seed key. Assume 1234 is chosen as the seed key. The data sent from A →B is encrypted with 1234, for example, (1234 <op>DATA), where “op” is an encryption algorithm.

The data received at B is then stored on the storage media in encrypted form as received. Later, A wants to retrieve the data from B. A and B negotiate a new key, for instance, 5678. When B sends the data to A, it transmits (5678 <op>(1234<op>DATA)) as opposed to the correct packet of (5678<op<DATA).

As a result, unless A has the original key available, A cannot decrypt the data.

Therefore, there is a need to resolve the aforementioned problem relating to the conventional approaches for storing content on storage media.

### BRIEF SUMMARY OF THE INVENTION

A first aspect of the present invention is a system for storing and retrieving encrypted content on a storage media. A key for accessing the encrypted content is stored along with the encrypted content on the storage media. The key is further encrypted with an encryption algorithm that may be kept secret, thus preventing unauthorized decryption of the stored data.

According to an alternate aspect of the present invention, a method is disclosed for storing the encrypted content on the storage media within a communication system having a terminal for receiving the encrypted content, the terminal being coupled to a storage media via an IEEE 1394 serial bus. The method comprises receiving the encrypted content via the IEEE 1394 bus, and encrypting a first key for decrypting the encrypted content to form a second key. In addition, the method includes combining the encrypted content with the second key to form a combined encrypted content stream; and storing the combined encrypted content stream on the storage media.

According to another aspect of the invention, the method further comprises, retrieving the combined encrypted content stream from the storage media. In addition, the second key is decrypted to obtain the first key; and while the encrypted content is encrypted with the first key to recover clear text content.

According to another aspect of the present invention, a method for storing encrypted data on a storage media is disclosed, wherein the encrypted data is decrypt-able with a first key. The method comprises receiving a transmission of the encrypted data; encrypting the first key to form a second key; and forwarding the second key and the encrypted data.

According to another aspect of the present invention, the method for storing further comprises storing the second key and the encrypted data on the storage media.

According to another aspect of the present invention, storing the second key on the storage media further comprises storing the second key within a header associated the encrypted data.

According to another aspect of the present invention, retrieving the second key and the encrypted data; and decrypting the second key to form the first key; and decrypting the encrypted data with the first key to form clear text.

According to another aspect of the present invention, encrypting the clear text using a third key to form combined encrypted data; and forwarding the combined encrypted data.

Advantageously, as noted, unauthorized decryption of the stored data is prevented while avoiding complexity.

### BRIEF DESCRIPTION OF THE DRAWINGS

FIG. 1 shows a prior art storage system used to store digital data received over an IEEE 1394 bus;

FIG. 2 shows a storage system constructed in accordance with the present invention;

FIG. 3 shows a detailed diagram of an interface module constructed in accordance with the present invention; and

FIG. 4 shows a method of storing encrypted data in accordance with the present invention.

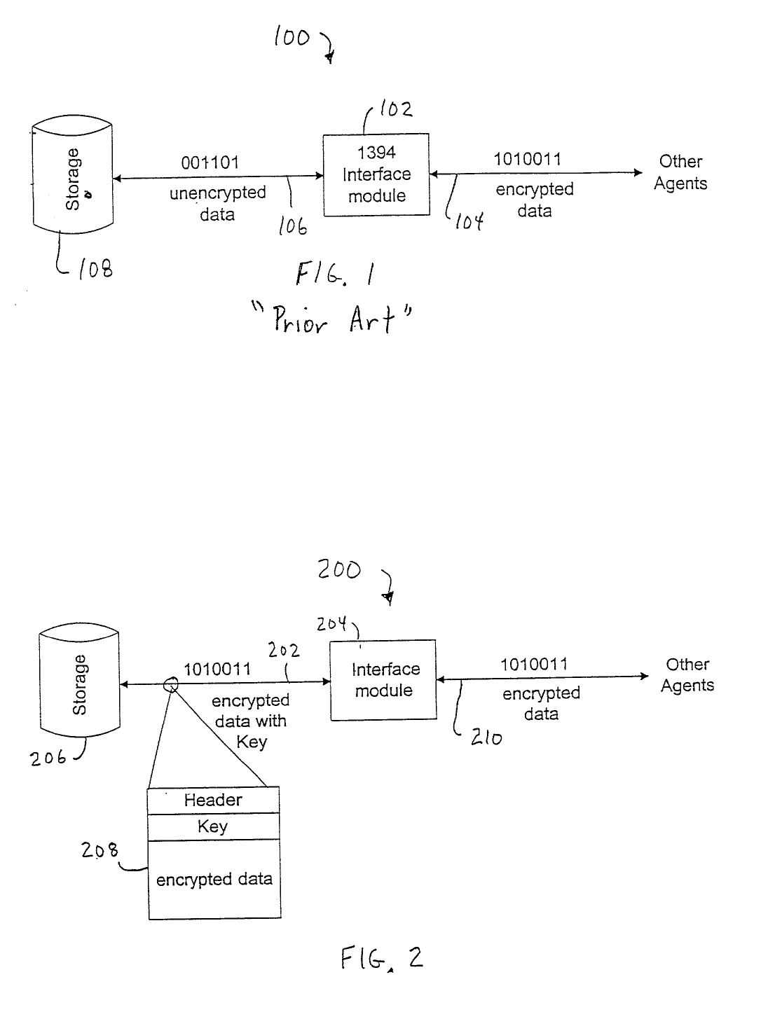

A further understanding of the nature and advantages of the present invention herein may be realized by reference to the remaining portions of the specification and the attached drawings. Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, the same reference numbers indicate identical or functionally similar elements. Reference numbers differing by multiples of 100 indicate identical or functionally similar elements except as modified to accommodate the present invention.

### DETAILED DESCRIPTION OF THE INVENTION

In a first embodiment of the invention, a solution to the above problems is provided by storing the key along with the encrypted data on the storage media. The key is further encrypted with an encryption algorithm that may be kept secret, thus preventing unauthorized decryption of the stored data.

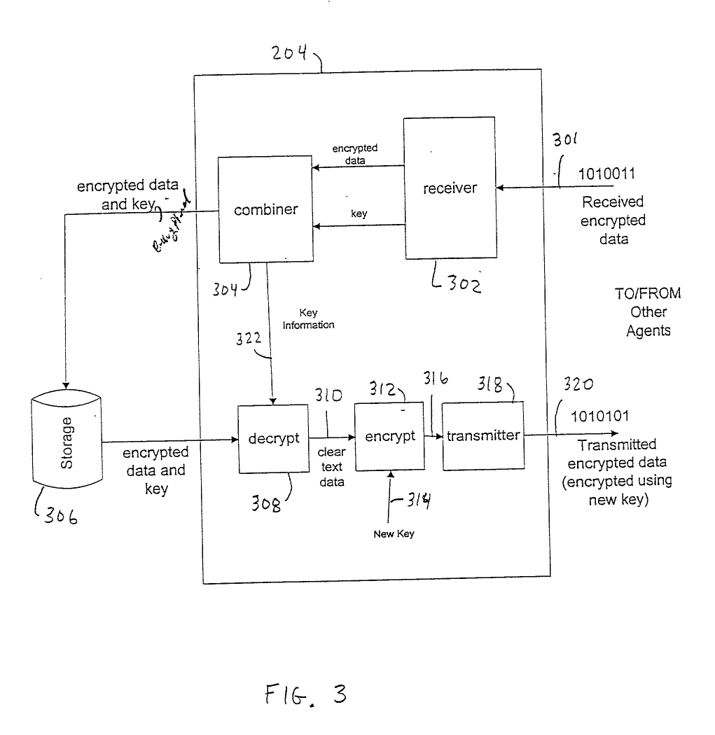

FIG. 2 shows a storage system 200 constructed in accordance with the present invention. Encrypted data transmitted from outside agents is received by an interface module 204 over bus 210. The interface module 204 sends the encrypted data to a storage media 206 for storage, via bus 202. The interface module 204 also stores an encryption key, associated with the encrypted data, in an associated data header record, as shown at 208. On data retrieval, the encrypted data is decrypted by the interface module 204 using the key stored in the header. The decrypted data is re-encrypted by the interface module 204 using a currently available key across the digital bus 210.

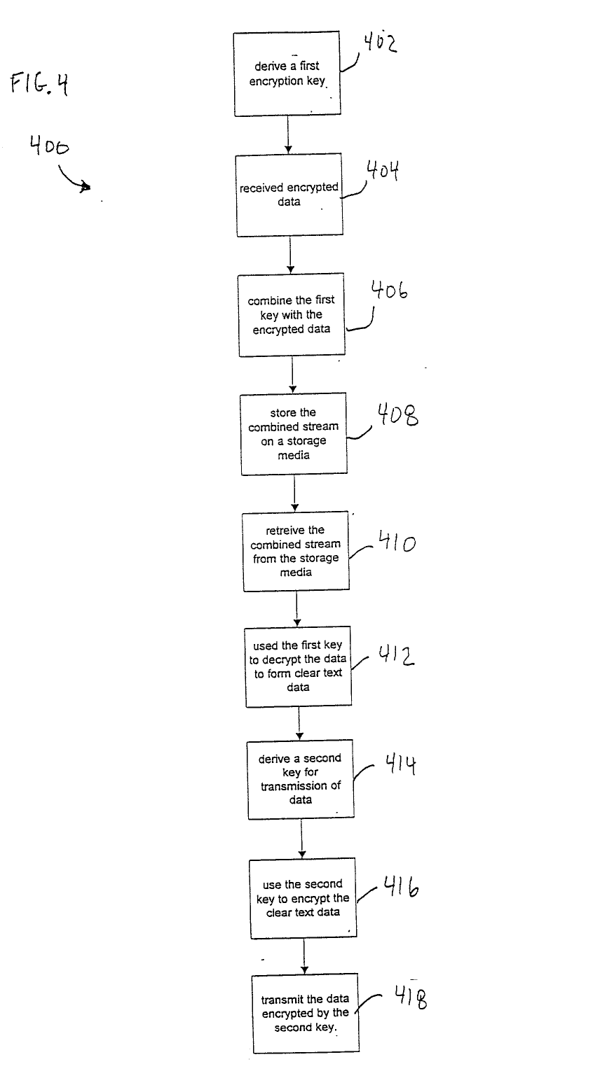

FIG. 3 shows a detailed block diagram of the interface module 204. Encrypted data received over a digital bus 301 by receiver 302 is combined with its associated key by a combiner 304. The combination of the encrypted data and key are then stored on the storage media 306. For example, the key may be included in a header record associated with the encrypted data. On retrieval, the encrypted data and key are input to a decryption module 308. The decryption module 308 operates to produce unencrypted data (“clear text data”) as shown at 310. The clear text data is input to an encryption module 312 that encrypts the data with a newly negotiated key 314 to produce the encrypted data stream shown at 316. The encrypted data stream 316 is input to a transmitter 318 that transmits the encrypted data to other agents via bus 320. Therefore, the interface module 204 allows encrypted data to be stored on a storage media and retrieved at a later time for retransmission, while still accounting for the different keys that may be involved.

In another embodiment of the invention, the combiner 304 further encrypts the encryption key prior to its storage on the media 306. In this embodiment, the combiner 304 provides the decrypt module 308 key information over path 322. The key information is used by the decrypt module 308 to recover the original key from the stored encrypted key. The encryption of the original key can be done using a completely different algorithm. For example, alternative encryption algorithms that may be used are: DES, XOR, M2, M6+,IDEA, and so forth. However, encryption of the original key is implementation dependent and should be determined based on various design considerations.

FIG. 4 shows a method 400 for storing encrypted data in accordance with the present invention. The method can be used with the storage system 300, however, the method is suitable for use with other types of storage systems coupled to other types of digital transmission systems that operate to receive, store and transmit encrypted data.

At block 402, a first encryption key is derived that is to be used to decrypt data received over a digital bus, for example, the digital bus 301. At block 404, encrypted data is received over the digital bus.

At block 406, the first encryption key is combined with the received data to form a combined data stream, for example, as performed by combiner 304. At block 408, the combined stream is stored on a storage media, such as a hard disk drive or CDROM-RW.

At block 410, the combined stream is retrieved from the storage media and at block 412 the first key is recovered and used to decrypt the retrieved encrypted data to form clear text data. For example, decrypt module 308 retrieves the combined stream and produces clear text data.

At block 414, a second key is derived that will be used to encrypt the clear text data for transmission over the digital bus. The second key may be different from the first key. For example, the second key may be derived months after the first key has expired.

At block 416, the clear text data is encrypted using the second key, for example, as performed by encrypt module 312. At block 418, the newly encrypted data is transmitted on the digital bus.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. In a communication system having a terminal for receiving encrypted content, the terminal being coupled to a storage media via an IEEE 1394 serial bus, a method for storing the encrypted content on the storage media, the method comprising:
receiving the encrypted content via the IEEE 1394 bus;
encrypting a first key for decrypting the encrypted content to form a second key;
combining the encrypted content with the second key to form a combined encrypted content stream; and
storing the combined encrypted content stream on the storage media.

2. The method of claim 1 further comprising
retrieving the combined encrypted content stream from the storage media;
decrypting the second key to obtain the first key; and
decrypting the encrypted content with the first key to recover clear text content.

3. A method for storing encrypted data on a storage media, the encrypted data being decrypt-able with a first key, the method comprising:
receiving a transmission of the encrypted data;
encrypting the first key to form a second key; and
forwarding the second key and the encrypted data.

4. The method of claim 3 further comprising storing the second key and the encrypted data on the storage media.

5. The method of claim 4 wherein storing the second key further comprises storing the second key within a header associated the encrypted data.

6. The method of claim 4 further comprising
retrieving the second key and the encrypted data;
decrypting the second key to form the first key; and
decrypting the encrypted data with the first key to form clear text.

7. The method of claim 6 further comprising encrypting the clear text using a third key to form combined encrypted data; and
forwarding the combined encrypted data.
